(19) United States
(12) Patent Application Publication
(10) Pub. No.: US 2005/0114547 A1
(43) Pub. Date: May 26, 2005

(54) Network address and port number translation system

(76) Inventor: Chien-Sheng Wu, Taipei City (TW)

Correspondence Address: CONNOLLY BOVE LODGE & HUTZ LLP, SUITE 800, 1990 M STREET NW, WASHINGTON, DC, 20036-3425, US

(21) Appl. No.: 10/866,037

(22) Filed: Jun. 14, 2004

(30) Foreign Application Priority Data
Oct. 6, 2003 (TW) 092127659

(51) Int. Cl. G06F 15/16

(52) U.S. Cl. 709/245

(57) ABSTRACT

A network address and port number translation (NAPT) system is disclosed, which applies hashing to search data and uses a data store pool to resolve collision on searching. In addition, a list header and the data store pool form a list of free public port numbers, such that a first available free (not used) public port number can be taken from the list header while a new connection is set up. Since the list is maintained with reference to the list header as well as the free public port numbers of the data store pool, the first available free public port number is recorded in a hashing table, thereby achieving a fast search purpose.

### BACKGROUND OF THE INVENTION

1. Field of the Invention

The present invention relates to the technical field of network address and port number translation (NAPT) and, more particularly, to a fast and flexible NAPT system.

2. Description of Related Art

Generally, the network address and port number translation (NAPT) is applied to overcome insufficient network address. Current solution uses a corresponding table (such as a NAT) implemented in a device with NAPT function (such as an IP gateway) to obtain network address and port number translation. Namely, when a machine in an intranet transmits its packets through the device to the Internet, the intranet may use linear search to sequentially search the corresponding table for replacing a private IP address and port number with a unique public port number for connecting to outside. As such, when different machines in the intranet send packets to the same external machine in the Internet, the external machine can distinguish the machines and determine which machine the packets come from. On the other hand, when a packet is sent back from the Internet to the intranet, the search is also required to replace the unique public port number with the original port number and a private IP address in order to determine the packet's destination. Such a search wastes a lot of time and can cause network bottleneck.

In addition, how the unique public port number is determined is an important issue. Current NAPT technique typically uses a random-like process to generate the unique public port number. Such a way is a poor efficient management for port numbers.

Therefore, it is desirable to provide an improved NAPT system to mitigate and/or obviate the aforementioned problems.

### SUMMARY OF THE INVENTION

The object of the present invention is to provide an improved NAPT system, which can effectively manage public port numbers, thereby shortening the required search time.

To achieve the object, the network address and port number translation (NAPT) system of the present invention includes a data store pool, a hashing table and a list header. The data store pool has a plurality of free port number entries for providing a plurality of free public port numbers to be used. The hashing table has a plurality of record entries for recording used public port numbers in a form of memory direct addressing index, thereby storing connection information in the memory. The list header accesses a first available free (not used) public port number. The first available free public port number of the list header and the free public port numbers of the data store pool form a list of free public port numbers, such that while a new connection is set up, the first available free public port number is taken from the list header and subsequently a next free public port number of the data store pool indicated by the list header is taken and subsequently stored in the list header as a next available free public port number to thus keep the list of free public port numbers in order. The first available free public port number taken is applied to the new connection and recorded in the hashing table as a used port number. Using this invention, system can generate the free port number easily and quickly.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a configuration of an embodiment according to the invention;

FIG. 2 is a schematic diagram of a new connection setup of FIG. 1 according to the invention;

FIG. 3 is a schematic diagram of another new connection setup of FIG. 1 according to the invention;

FIG. 4 is a schematic diagram of FIG. 3 in consideration with collision occurrence according to the invention;

FIG. 5 is a schematic diagram of FIG. 3 in consideration with no used connection information according to the invention;

FIG. 6 is a schematic diagram of FIG. 3 in consideration with free public port numbers as direct index addressing according to the invention; and

FIG. 7 is a schematic diagram of FIG. 3 in consideration with a hashing table included in a data store pool according to the invention.

### DETAILED DESCRIPTION OF THE PREFERRED EMBODIMENT

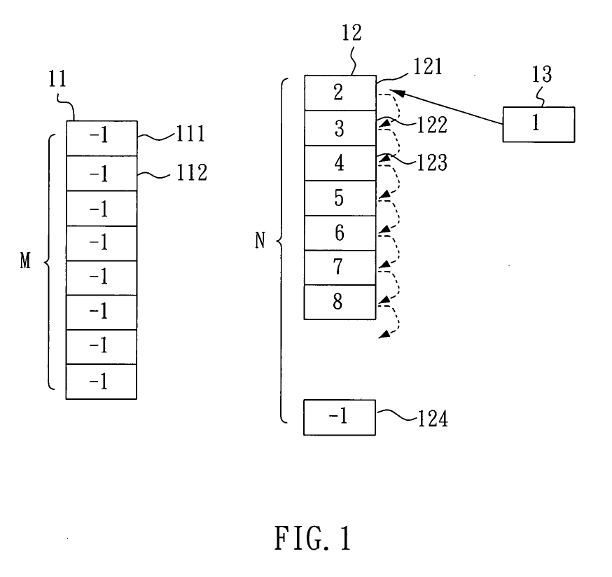

FIG. 1 is a schematic diagram of the inventive configuration. The configuration illustrates a packet delivery from an intranet to an external network through a network address translator (NAT), which is hereinafter referred to as V2G (Virtual network to Global network) and applies hashing to achieve a fast search.

In FIG. 1, the configuration essentially includes a hashing table 11, a data store pool 12 and a list header 13. As shown in FIG. 1, the size of the hashing table 11 is M; i.e., there are M record entries as indicated by 111 and 112. In combination with hashing value Kn derived from a hash function, information is recorded in the associated record entries 111 and 112. In this embodiment, the record entries 111 and 112 respectively have an initial value −1, which indicates no information about the connection through the NAT system. The size of the data store pool 12 is N; i.e., there are N port number entries as indicated by 121, 122, 123, . . . , 124. In this case, for a 16-bit public port number, the maximum N value is 65535.

In this embodiment, the data store pool 12 can resolve collisions encountered when different hashing keys derived from a hash function corresponds to one or more same entries in the hashing table 11. A combination of the data store pool 12 and the list header 13 is applied to record which current public port numbers can be distributed to use. For example, if a distributed public port number is X, it means that all information associated with a connection corresponding to the number X is stored in X-th position of a used memory. In this embodiment, the data store pool 12 is only an example set of partial free public port numbers. Namely, the free public port numbers in the data store pool 12 are predetermined for use in special connection, thereby effectively using the port numbers to obtain optimal configuration. For example, port numbers 980˜1200 are used specially in SIP connection. The following describes how the hashing table 11, the data store pool 12 and the list header 13 are applied to achieve a fast search purpose.

In this embodiment, initial values of the record entries 111 and 112 in the hashing table 11 are set to −1 representing no associated connection information. In addition, initial values of the list header 13 are set to 1 representing free public port numbers available to be distributed. Namely, while a new outward connection is set up, any public port number with 1 can be used. The next free public port number is 2 if the first port number entry 121 of the data store pool 12 is 2, the next free public port number after the cited number 2 is 3, and so on, thereby forming a list of free public port number, which includes N-th port number entry 124 having a value of −1 to represent the list end. Accordingly, the list of free public port numbers is formed as follows:
1→2→3→4→5 . . . →124→−1.

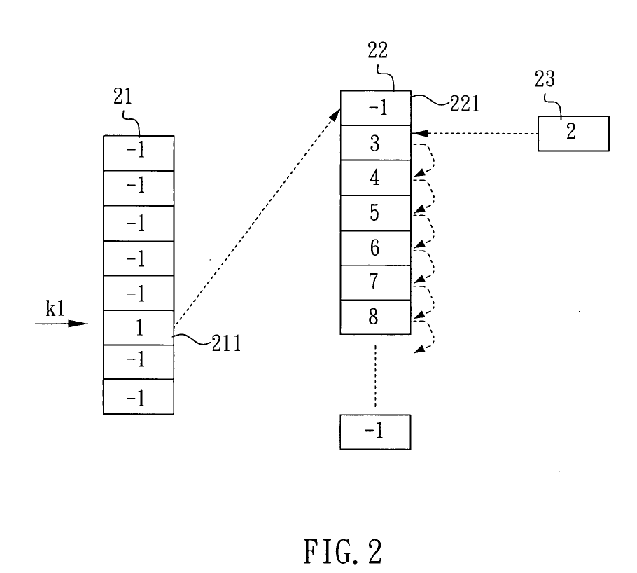

FIG. 2 is a schematic diagram of a new connection setup. For a new connection setup, a hash function is executed to generate a hashing value k1. The hash function is executed by giving source address and source port number as hashing keys, thus obtaining the hashing value k1. Because the record entry 211 of the hashing table 21 indicated by the hashing value k1 initially has a value of −1 representing no associated connection information, a free public port number of 1 is taken from the list header 23, and the next free public port number of 2 is recorded in the list header 23 from the first port number entry 221 of the data store pool 22. In addition, the first port number entry 221 is changed into −1. Next, the public port number of 1 obtained is recorded in the record entry 211 of the hashing table 21 indicated by the hashing value k1. Thus, the record entry 211 of the hashing table 21 becomes 1, the list header 23 becomes 2, and the first port number entry 221 of the data store pool 22 becomes −1. Accordingly, a list of free public port number is formed as 2→3→4→5→ . . . →124→−1, and a list of hashing values for k1 is formed as 1→−1.

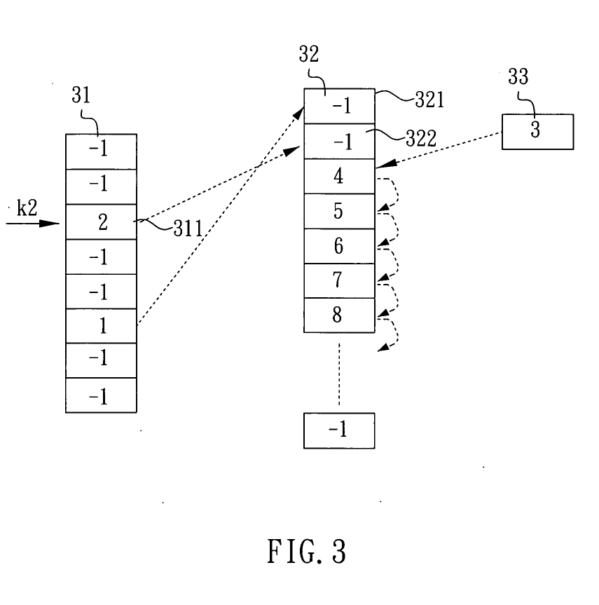

FIG. 3 is a schematic diagram of another new connection setup. With reference to FIGS. 2 and 3, for another new connection setup, the hash function is also executed to generate another hashing value k2. Because the hashing value k2 indicates a record entry 311 of a hashing table 31 and the record entry 311 initially has a value −1, a free public port number 2 is taken from a list header 33 and the free public port number 2 is recorded in the record entry 311 of the hashing table 31, such that the record entry 311 of the hashing table 31 is 2, the first and second port number entries 321, 322 of a data store pool 32 are −1 respectively, and the list header 33 is 3. Accordingly, a list of free public port number is formed as 3→4→5→ . . . →124→−1, and a list of hashing values for k2 is formed as 2→−1.

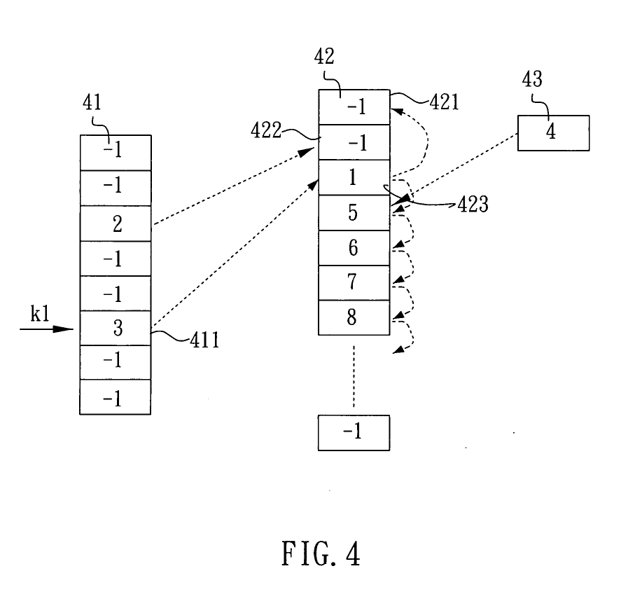

FIG. 4 is a schematic diagram of FIG. 3 in consideration with collision occurrence. With reference to FIGS. 3 and 4, for the new connection setup, the hash function is operated to generate a hashing value k1. Since the hashing value k1 indicates the same position as in FIG. 2 and a record entry 411 of a hashing table 41 records the public port number 1, a collision occurs when the record entry 411 requires recording a new public port number. As such, the invention firstly uses a list header 43 to acquire a free public port number 3 and then the next free public port number 4 is taken from the third port number entry 423 of the data store pool 42 in order to record the number 3 in the list header 43. In addition, the free public port number 3 acquired is recorded in the record entry 411 of the hashing table 41, and the public port number 1 originally stored in the record entry 411 is placed in the third port number entry 423 of the data store pool 42. Therefore, a list of free public port numbers is formed as 4→5→ . . . →1 2 4→−1. At this point, the hashing value k1 indicates the hashing table 41 at a position having two connections, i.e., the public port numbers 3 and 1, but the collision can be resolved by sequentially comparing 3→1, accordingly to determine one of the two, even the hashing value k1 generated by the hash function indicates to the same position when a packet uses the public port number of 3 or 1 for connection.

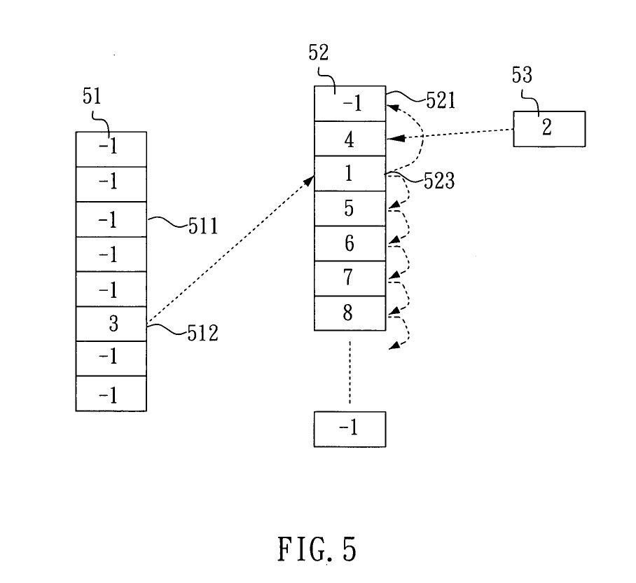

How free public port numbers are obtained, maintained and further recorded in the hashing table is described above. However, when connection information recorded in the table is unused, the connection information unused needs to be removed from the table for being recycled to the list of free public port numbers. FIG. 5 is a schematic diagram showing that the connection information unused is removed. As shown in FIG. 5, when a connection using the public port number 2 is terminated, a record entry 511 of a hashing table 51 indicated by the hashing value k2 is rewritten into −1, to indicate no connection information stored in the record entry 511 and subsequently the connection information for the public port number 2 is relatively removed from the hashing table 51. Next, the public port number 2 is returned to a list header 53, to maintain the list in order. Therefore, the list becomes 2→4→5→ . . . →1 2 4→−1. Similarly, when a connection using the public port number 3 is terminated, the same release procedure as for the public port number 2 is performed, such that a record entry 512 (indicated by the hashing value k1) of the hashing table 51 is 1, the first port number entry 521 of a data store pool 52 is −1 and the third port number entry 523 is 2. Therefore, the list becomes 3→2→4→5→ . . . →1 2 4→−1 and a list of hashing values for k1 is formed as 1→−1.

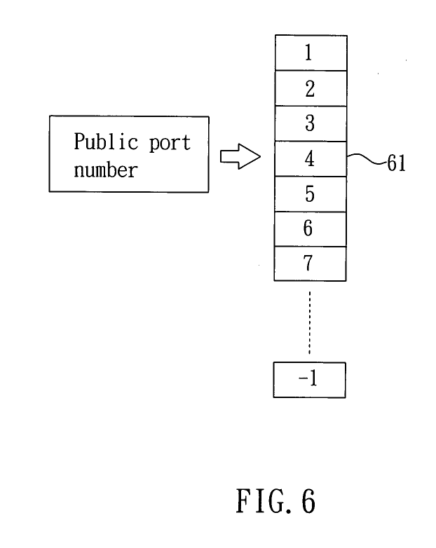

Because the public port number for outward connection is unique, the public port number can be used as a key index value of G2V (Global network to Virtual network), when packets of the connection are return from internet to intranet, thereby directly addressing to memory. As shown in FIG. 6, if a public port number for a new outward connection is 1500, associated information corresponding to the new connection is stored in 1500-th storage unit of a memory 61, a connection from G2V only requires directly using the public port number as a reverse look-up directly to the 1500-th storage unit of the memory 61 for the associated information, thus increasing search speed and quickly completing translation.

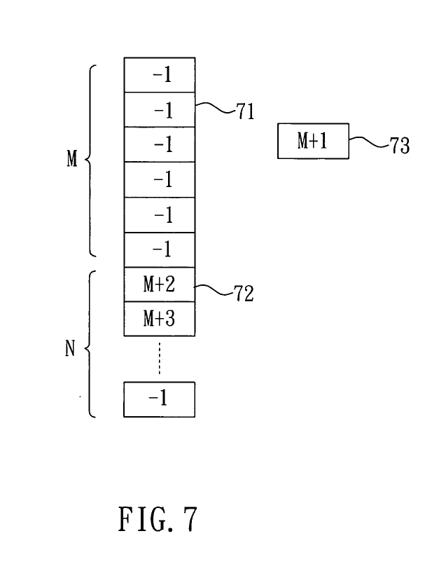

To save memory for recording the free public port numbers, the hashing table can be integrated into the data store pool. FIG. 7 is a schematic diagram of a combination of the hashing table 71 and the data store pool 72. As shown in FIG. 7, it is cited above that initial values of the hashing table 71 are −1 representing no associated information, the list is ended by a value of −1 in the data store pool 72 and a list header 73 records a first available free public port number. When the size of the data store pool 72 is N and the size of the hashing table 71 is M, the first available free public port number initially in the list header 73 is M+1. In addition, acquiring a free public port number, maintaining the data storage stack 72, being recorded in the hashing table 71 and resolving collision can be performed similar to the above process and thus a detailed description is deemed unnecessary.

Although the present invention has been explained in relation to its preferred embodiment, it is to be understood that many other possible modifications and variations can be made without departing from the spirit and scope of the invention as hereinafter claimed.

1. A network address and port number translation (NAPT) system, comprising:
a data store pool having a plurality of free port number entries for providing a plurality of free public port numbers to be used;
a hashing table having a plurality of record entries for recording used public port numbers and using the used public port numbers as direct addressing index values to a memory, thereby storing connection information in the memory; and
a list header, for accessing a first available free public port number, wherein the first available free public port number and the free public port numbers of the data store pool form a list of free public port numbers, such that when a new connection is set up, the first available free public port number is taken from the list header and subsequently a next free public port number of the data store pool indicated by the list header is taken and subsequently stored in the list header as a next available free public port number to thus maintain the list of free public port numbers, and the first available free public port number taken is applied to the new connection and recorded in the hashing table.

2. The NAPT system as claimed in claim 1, wherein the free public port numbers are predetermined to provide a special connection.

3. The NAPT system as claimed in claim 2, wherein the special connection is H.323 or SIP special application services.

4. The NAPT system as claimed in claim 1, wherein the first available public port number taken from the list header is recorded in a record entry of the hashing table, the record entry being located at a position indicated by a hashing value which is obtained by using the new connection's source address and source port as hashing keys in operation.

5. The NAPT system as claimed in claim 1, wherein when the first available free public port number is taken from the list header, the first available one of the free public port numbers in the data store pool is recorded in the list header as a new first available free public port number, and a free port number entry of the data store pool for the first available one of the free public port numbers is remarked, thus to change the list of the free public port numbers for connection.

6. The NAPT system as claimed in claim 1, wherein when the hashing table encounters a collision, the first available free public port number is first taken from the list header, the next first available one of the free public port numbers in the data store pool is recorded in the list header as a new first available free public port number, a free public port number, which is originally stored in the hashing table on collision, is stored in a free port number entry corresponding to the first available free public port number, and the first available free public port number is recorded in the hashing table.

7. The NAPT system as claimed in claim 1, wherein the hashing table is included in the data store pool.
